(19) United States
(12) Patent Application Publication
(10) Pub. No.: US 2006/0294113 A1
(43) Pub. Date: Dec. 28, 2006

(54) Joint spatial-temporal-orientation-scale prediction and coding of motion vectors for rate-distortion-complexity optimized video coding

(76) Inventors: Deepak Turaga, Elmsford, NY (US); Mihaela Van Der Schaar, Martinez, CA (US)

Correspondence Address: PHILIPS INTELLECTUAL PROPERTY & STANDARDS, P.O. BOX 3001, BRIARCLIFF MANOR, NY, 10510, US

(21) Appl. No.: 10/569,254

(22) PCT Filed: Aug. 17, 2004
(86) PCT No.: PCT/IB04/51474

§ 371 Date: Feb. 21, 2006

Related U.S. Application Data
(60) Provisional application No. 60/497,351, filed on Aug. 22, 2003.

(51) Int. Cl. G06F 7/00

(52) U.S. Cl. 707/100

(57) ABSTRACT

Several prediction and coding schemes are combined to optimize performance in terms of the rate-distortion-complexity tradeoffs. Certain schemes for temporal prediction and coding of Motion Vectors (MVs) are combined with a new coding paradigm of over complete wavelet video coding. Two prediction and coding schemes are set forth herein. A first prediction and coding scheme employs prediction across spatial scales. A second prediction and coding scheme employs a motion vector prediction and coding across different orientation sub-bands. A video coding scheme utilizes joint prediction and coding to optimize the rate, distortion and the complexity simultaneously.

The present invention relates generally to methods and apparatuses for encoding video and more particularly to a method and apparatus for encoding video using prediction based algorithms for motion vector estimation and encoding.

Spatial prediction (from neighbors) for motion vector (MV) estimation and coding is used extensively in current video coding standards. For example, spatial prediction of MVs from neighbors is used in many predictive coding standards, such as MPEG 2, 4 and H.263. Prediction and coding of MVs across temporal scales was disclosed by the same inventors in U.S. Patent Provisional Application No. 60/416,592 filed on Oct. 7, 2002, which is hereby incorporated by reference as if repeated herein in its entirety. A related application (i.e., related to 60/416,592) was filed by the same inventors on even date herewith, which related application is also hereby incorporated by reference.

One method of prediction and coding of MVs across spatial scales was introduced by Zhang and Zafar in U.S. Pat. No. 5,477,272, which is hereby incorporated by reference as if repeated herein in its entirety, including the drawings.

Despite these improvements in video coding, demand continues for improved processing efficiency in video coding to reduce processing speed and coding gain without sacrificing quality.

The present invention is therefore directed to the problem of developing a method and apparatus for increasing the processing efficiency in video coding without sacrificing quality.

The present invention solves these and other problems by providing several prediction and coding schemes, as well as a method of combining these different schemes to optimize performance in terms of the rate-distortion-complexity tradeoffs.

Certain schemes for temporal prediction and coding of Motion Vectors (MVs) were disclosed in U.S. Patent Application No. 60/416,592. In combination with the new coding paradigm of over-complete wavelet video coding, two prediction and coding schemes are set forth herein. A first prediction and coding scheme employs prediction across spatial scales. A second prediction and coding scheme employs a motion vector prediction and coding across different orientation sub-bands. According to still another aspect of the present invention, a video coding scheme utilizes joint prediction and coding to optimize the rate, distortion and the complexity simultaneously.

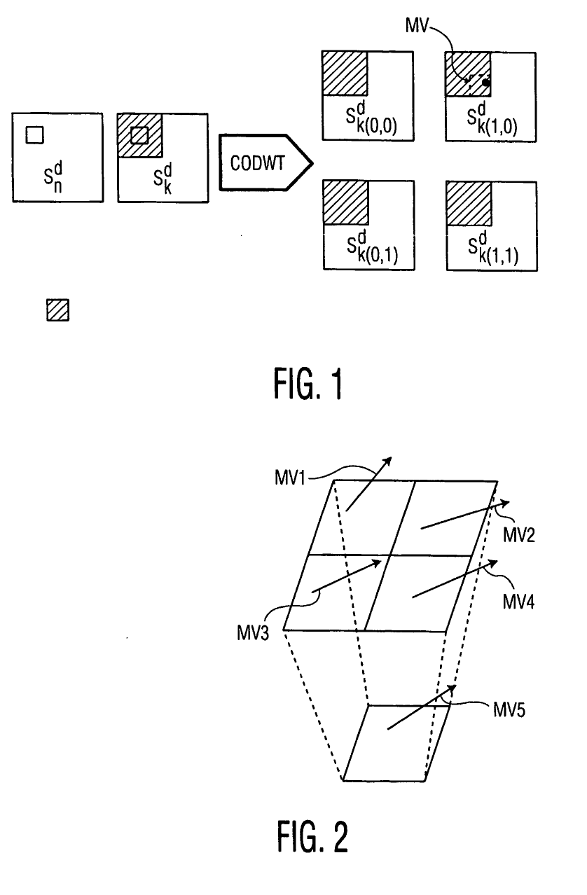

FIG. 1 depicts a block diagram of a process for performing a motion vector estimation coding using a CODWT according to one aspect of the present invention.

FIG. 2 depicts a block diagram of a process for performing motion vector estimation coding across spatial scales according to another aspect of the present invention.

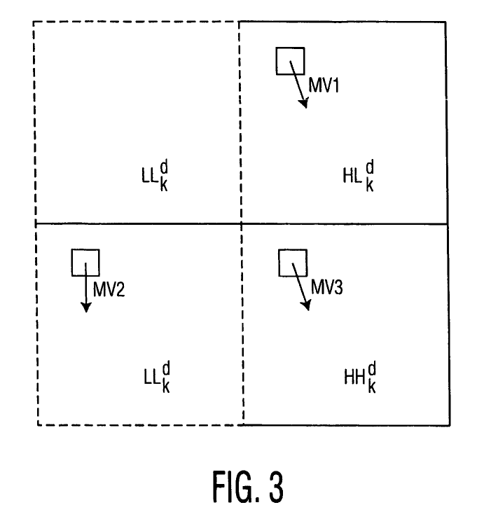

FIG. 3 depicts a block diagram of a process for performing motion vector estimation coding across sub-bands at the same spatial scales according to yet another aspect of the present invention.

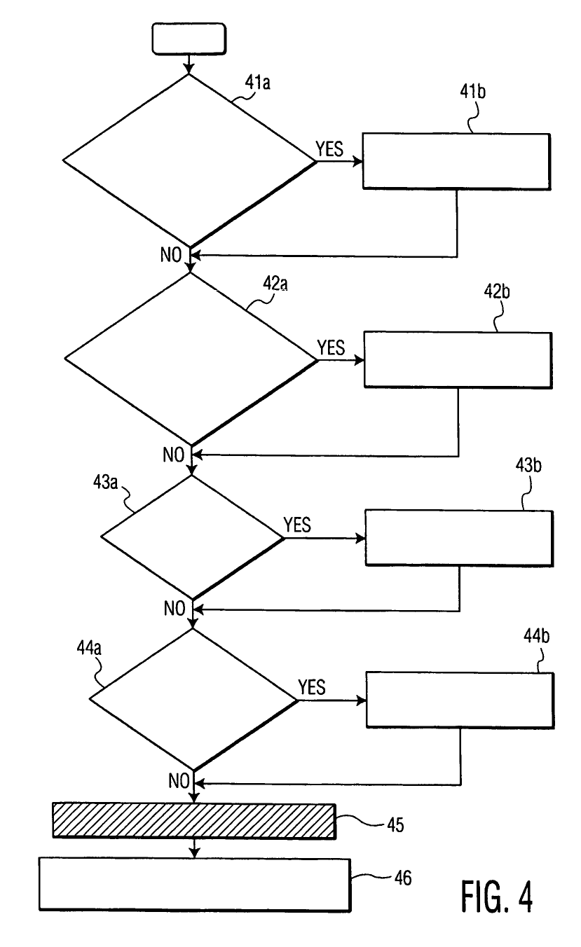

FIG. 4 depicts a flow chart of a process for performing motion vector estimation coding using a plurality of techniques according to still another aspect of the present invention.

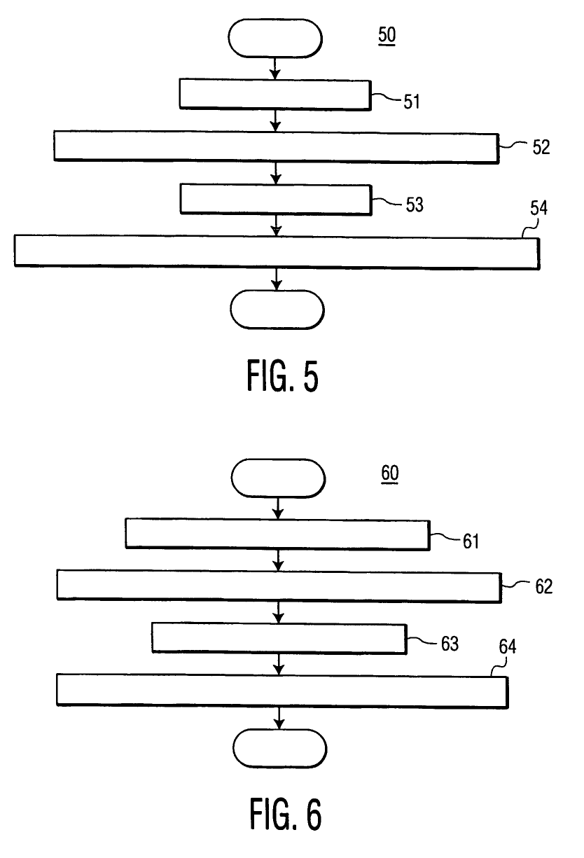

FIG. 5 depicts a flow chart of a process for prediction and coding across different orientation subbands according to another aspect of the present invention.

FIGS. 6-8 depict exemplary embodiments of methods for calculating motion vectors using a prediction across spatial scales.

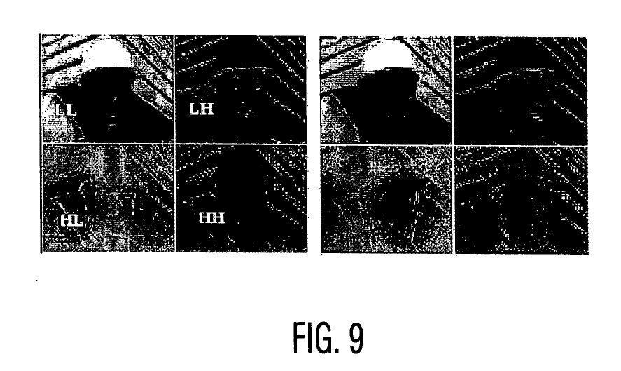

FIG. 9 depicts two frames from a Foreman sequence after one level of a wavelet transform, in which the two frames are decomposed into different subbands according to still another aspect of the present invention.

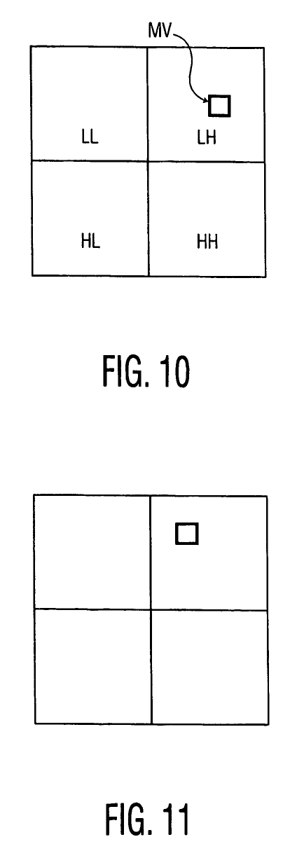

FIG. 10 depicts reference frame used in a prediction across different orientation subbands according to another aspect of the present invention.

FIG. 11 depicts a current frame used in a prediction across different orientation subbands according to another aspect of the present invention.

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Recently, much interest has been generated by over-complete motion compensated wavelet video coding. In this scheme, spatial decomposition is first performed, and then multi-resolution motion compensated temporal filtering (MCTF) is performed independently on each of the resulting spatial sub-bands. In such schemes, motion vectors are available at different resolutions and orientations, thereby enabling good quality decoding at different spatio-temporal resolutions. Also, temporal filtering may be performed, keeping in mind the texture information to preserve important features, such as edges. However, with such schemes, there is a much larger overhead in terms of the number of motion vectors that need to be encoded.

In order to perform motion estimation (ME), the over-complete discrete wavelet transform (ODWT) is constructed from the critically sampled decomposition of the reference frame(s) assuming resolution scalability. The ODWT is constructed from the Discrete Wavelet Transform (DWT) using a procedure called complete-to-over-complete discrete wavelet transform (CODWT). This procedure occurs at both the encoder and decoder side for the reference frame(s). So after the CODWT, a reference sub-band Sₖ^{d} (i.e., frame k, from the wavelet decomposition level d) is represented as four critically sampled sub-bands S_{k(0,0)}^{d}, S_{k(1,0)}^{d}, S_{k(0,1)}^{d} and S_{k(1,1)}^{d}. The subscript within brackets indicates the polyphase components (even=0, odd=1) retained after the down-sampling in the vertical and horizontal direction. The motion estimation is performed in each of these four critically sampled reference sub-bands, and the best match is chosen.

Thus, each motion vector also has an associated number to indicate to which of the four components the best match belongs. The motion estimation and motion compensation (MC) procedures are performed in a level-by-level fashion, for each of the sub-bands (LL, LH, HL and HH). In this approach, similar to the methods where MCTF is performed first, variable block sizes and search ranges can be used per resolution level.

However, in providing good temporal de-correlation, these extensions need to code additional sets of motion vectors (MVs). Since bi-directional motion estimation is performed at multiple spatio-temporal levels, the number of additional MVs bits increases with the number of decomposition levels. Similarly, the larger the number of reference frames used during the filtering, the more the MVs that need to be coded.

We can define a “temporal redundancy factor” Rₗ, as the number of MV fields that need to be encoded with these schemes, divided by the number of MV fields in the Haar decomposition (which is the same as the number of MV fields in a hybrid coding scheme). Then, with Dₜ temporal decomposition levels, bidirectional filtering, and a GOF size multiple of 2^{D}^{ₜ}, this factor is:

$${R}_{t} = \frac{{2}^{{D}_{t}} - {D}_{t}}{{2}^{{D}_{t} - 1} - 1} \approx 2.$$

Similarly, we may compute this redundancy factor for different decomposition structures. The spatial motion vector redundancy factor Rₛ for such an over-complete wavelet coding scheme may also be similarly defined. A scheme with Dₛ spatial decomposition levels has a total of number of 3Dₛ+1 sub-bands. There are many ways of performing ME and temporal filtering on these sub-bands, each with a different redundancy factor.
1. Reduce, by a factor of 4, the smallest block size with increasing spatial decomposition level number. This ensures that each sub-band has the same number of motion vectors. In such a case the redundancy factor is Rₛ=3Dₛ+1. One way to decrease this redundancy, at the cost of reduced efficiency, is to use one motion vector for blocks from the three high frequency sub-bands at each level. In such a case the redundancy factor is reduced to Rₛ=Dₛ+1.
2. Use the same smallest block size at all spatial decomposition levels. In such a case the number of motion vectors decreases by a factor of four at each successive spatial decomposition level. In such a case, the total redundancy may be computed as

$${R}_{s} = {\sum }_{i = 1}^{{D}_{s}} 3 ( \frac{1}{{4}^{i}} ) + ( \frac{1}{{4}^{{D}_{s}}} ) = ( 1 - \frac{1}{{4}^{{D}_{s}}} ) + ( \frac{1}{{4}^{{D}_{s}}} ) = 1.$$
However, keeping the same block size at different spatial levels can significantly degrade the quality of the motion estimation and temporal filtering. Simultaneously, if we further impose the restriction that we use only one motion vector for the blocks of the three high-frequency sub-bands at each level, the redundancy factor decreases to

$$\begin{matrix}{R}_{s} = {\sum }_{i = 1}^{{D}_{s}} ( \frac{1}{{4}^{i}} ) + ( \frac{1}{{4}^{{D}_{s}}} ) \\ = \frac{1}{3} ( 1 - \frac{1}{{4}^{{D}_{s}}} ) + ( \frac{1}{{4}^{{D}_{s}}} ) \\ = \frac{1}{3} ( 1 + \frac{2}{{4}^{{D}_{s}}} ) \leq 1.\end{matrix}$$

Importantly, this redundancy factor Rₛ is independent of the temporal redundancy factor Rₗ, derived earlier. When bi-directional filtering etc. is used in this framework, the resulting redundancy factor is a product of Rₗ and Rₛ.

In summary, for efficient temporal filtering of the video sequence, many additional sets of MVs need to be encoded. In this disclosure we introduce different prediction and coding schemes for MVs that exploit some of the spatio-temporal-directional-scale correlations between them. Such schemes can reduce the bits needed to code MVs significantly, while also enabling MV scalability in different dimensions. Simultaneously, tradeoffs between coding efficiency, quality and complexity can also be explored with these schemes.

Prediction Across Spatial Scales

These schemes for MV prediction and coding are applicable in the over-complete temporal filtering domain, where ME is performed across many spatial scales. Due to the similarities between sub-bands at different scales, we may predict MVs across these scales. In order to simplify the description we consider some motion vectors in FIG. 2.

In FIG. 2 we show two different spatial decomposition levels, and show blocks corresponding to the same region in the two levels. We consider the example when we use the same block size for Motion Estimation (ME) at different spatial levels. When we reduce the block size at different spatial decomposition levels, we have the same number of motion vectors at all the spatial levels (MV5 is split into four MVs for the four small sub-blocks at level d), and prediction and coding schemes defined here may be easily extended to that case.

As with the prediction across temporal scales, we can define top-down, bottom-up and hybrid prediction schemes.

Top-Down Prediction and Coding

In this scheme, we use MVs at spatial level d−1 to predict MVs at temporal level d and so on. Using our example in FIG. 2, as shown in FIG. 6, this process 60 may be written as:

a. Determine MV1, MV2, MV3, and MV4 (element 61).

b. Estimate MV5 as a refinement based on these four MVs (element 62).

c. Code MV1, MV2, MV3, MV4 (element 63).

d. Code refinement for MV5 (or no refinement) (element 64).

Similar to top-down temporal prediction and coding, this scheme is likely to have high efficiency, however it does not support spatial scalability. Also, we can continue to use Motion Vector (MV) prediction during the estimation process as well, i.e., predict the search center and search range for MV5 based on MV1, MV2, MV3 and MV4.

Hybrid: Top-Down Estimation, Bottom-Up Coding

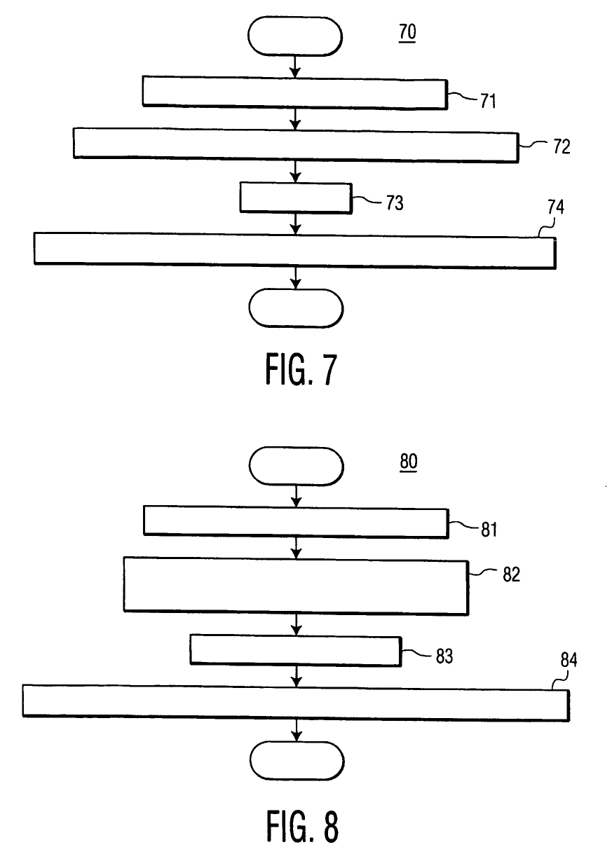

Shown in FIG. 7, is another exemplary embodiment 70 of a method using prediction across spatial scales as shown in FIG. 6.

a. Determine MV1, MV2, MV3 and MV4 (element 71)

b. Determining MV5, such that MV1, MV2, MV3 and MV4 require few bits (element 72)

c. Code MV5 (element 73).

d. Code the refinement for MV1, MV2, MV3 and MV4 or no refinement at all (element 74).

Mixed Prediction: Use MVs from Different Levels Jointly as Predictors

Shown in FIG. 8, is another exemplary embodiment 80 of a method using prediction across spatial scales as shown in FIGS. 6-7.

a. Determine MV1, MV2, and MV5 (element 81)

b. Estimate MV3 and MV4 as a refinement based on MV1, MV2 and MV5 (element 82).

c. Code MV5, MV2 and MV1 (element 83).

Code the refinement for MV3 and MV4 or no refinement at all (element 84).

The advantages and disadvantages of some of these schemes are similar to those defined in Disclosure 703530 for the temporal prediction and coding.

Prediction and Coding Across Different Orientation Subbands at Same Spatial Level

Referring to FIG. 5, shown therein is a process for prediction and coding across different orientation subbands. The above schemes for MV prediction and coding exploit the similarity in motion information of sub-bands at the same spatial decomposition level in the overcomplete temporal filtering domain. The different high frequency spatial subbands at a level are the LH, the HL, and the HH. Since these correspond to different directional frequencies (orientations) in the same frame, they have correlated MVs. Hence prediction and coding can be performed jointly or across these directional subbands.

As shown in FIG. 3, MV1, MV2 and MV3 are motion vectors corresponding to the block in the same spatial location, in the different frequency subbands (different orientations). One way of predictive coding and estimation as shown in FIG. 5 operates as follows.

a. Determine MV1 (element 51)

b. Estimate MV2 and MV3 as refinements based on MV1 (element 52)

c. Code MV1 (element 53)

d. Code refinements for MV2 and MV3 (or no refinement at all) (element 54).

The above may be rewritten with MV1 replaced by MV2 or MV3. Also, the scheme may easily be modified such that two of the three are used as predictiors for the third MV.

Estimation of Motion Vectors for Orientation Subbands

In the overcomplete wavelet coding framework, motion estimation and compensation is performed after the spatial wavelet transform. As an example, in FIG. 9 we show two frames from the Foreman sequence after one level of the wavelet transform. As may be seen the two frames are decomposed into different subbands: the LL (approximation) and the LH, HL and HH subbands (detail subbands). The LL subband may be further decomposed at multiple levels to obtain a multi-level wavelet transform.

The three detail subbands LH, HL and HH are also called directional subbands (as they capture vertical, horizontal and diagonal frequencies respectively). Motion estimation and compensation needs to be performed for blocks in each of these three orientation subbands. This is pictorially shown for the LH subband in FIGS. 10 and 11.

Similarly for each block in the HL and HH subbands the corresponding MV and best matches have to be found from the HL and HH subbands in the reference frame. However, it may be clearly seen that there exist dependencies between these subbands, so blocks in the same position in these different subbands are likely to have similar motion vectors. Hence the MVs for the blocks from these different frames may be predicted from one another.

Joint Prediction and Coding of MVs

Referring to FIG. 4, shown therein is a method 40 for using a joint prediction and coding of Motion Vectors according to another aspect of the present invention. In summary, there are four broad categories of prediction and coding schemes for MVs. These are
Prediction from spatial neighbors (SN), which is a known technique used in predictive coding standards, such as MPEG 2, 4 and H.263.
Prediction across temporal scales (TS), which is set forth in U.S. Patent Application No. 60/483,795 (U.S. Pat. No. 020379).
Prediction across spatial scales (SS) (see FIGS. 6-8).
Prediction across different orientation subbands (OS) (as is described above with reference to FIG. 5).

Schemes from one or more of these categories may be jointly used at the encoder in order to obtain better predictions for the current MV. We may show this as a flowchart in FIG. 4.

The Cost associated with each of the different predictions is defined as a function of rate, distortion and complexity. Cost=f(Rate, Distortion, Complexity). The exact cost function must be chosen based on the application requirements, however, in general most cost functions of these parameters will suffice.

After calculating each of the prediction motion vectors and their cost, whether to use these calculated motion vectors in the combined version can be determined based on the cost function.

Different functions may be used to combine the available predictions (shaded block) from each of these broad categories. Two examples are the weighted average and the median function:
PMV=α_{SN}PMV_{SN}+α_{TS}PMV_{TS}+α_{SS}PMV_{SS}+α_{OS}PMV_{OS}
or PMV=median(PMV_{SN},PMV_{TS},PMV_{SS},PMV_{OS}).

The weights used during such a combination (αs) should be determined based on the cost associated with each of the prediction strategies, and also the desired features that the encoder and decoder need to support. For instance, if the temporal prediction scheme has a high associated cost, then it should be assigned a small weight. Similarly, if spatial scalability is a requirement, then bottom-up prediction schemes should be preferred to top-down prediction schemes.

This choice of available prediction schemes, the combination function, and the assigned weights need to be sent to the decoder so that it can decode the MV residues correctly.

By enabling these different prediction schemes, we may exploit tradeoffs between rate-distortion-complexity. As an example, if we do not refine the prediction for the current MV, we need not perform motion estimation for the current MV, i.e. we can reduce the computational complexity significantly. Simultaneously, by not refining the MV, we require fewer bits to code the MVs (since the residue is now zero). However, both these come at the cost of having poorer quality matches. Hence, an intelligent tradeoff needs to be made based on the encoder and decoder requirements and capabilities.

The above methods and processes are applicable to any interframe/overcomplete wavelet codec based product, including as examples but not limited to: scalable video storage modules, and internet/wireless video transmission modules.

Although various embodiments are specifically illustrated and described herein, it will be appreciated that modifications and variations of the invention are covered by the above teachings and are within the purview of the appended claims without departing from the spirit and intended scope of the invention. For example, certain products are described in which the above methods may be employed, however, other products may benefit from the methods set forth herein. Furthermore, this example should not be interpreted to limit the modifications and variations of the invention covered by the claims but is merely illustrative of possible variations.

What is claimed is:

1. A method for computing motion vectors for a frame in a full-motion video sequence, comprising:
determining whether to use one or more temporal scale prediction motion vectors (PMV_{TS}) calculated using a prediction across temporal scales based on a calculated cost function associated with the one or more temporal scale prediction motion vectors (41a, 41b);
determining whether to use one or more spatial neighbor prediction motion vectors (PMV_{SN}) calculated using a prediction across spatial neighbors based on a calculated cost function associated with the one or more spatial neighbor prediction motion vectors (43a, 43b); and
combining all prediction motion vectors determined to be used and using the combined prediction for estimating and encoding a current motion vector (45, 46).

2. The method according to claim 1, further comprising:
determining whether to use one or more spatial scale prediction motion vectors (PMV_{SS}) calculated using a prediction across spatial scales based on a calculated cost function associated with the one or more spatial scale prediction motion vectors (42a, 42b).

3. The method according to claim 1, further comprising:
determining whether to use one or more orientation subband prediction motion vectors (PMV_{OS}) calculated using a prediction from a different orentiation subband based on a calculated cost function associated with the one or more orientation subband prediction motion vectors (44a, 44b).

4. The method according to claim 2, wherein said step of determining whether to use one or more spatial scale prediction motion vectors includes:
determining a first set of four motion vectors (51);
estimating a fifth motion vector based on the first set (52);
coding each motion vector in the first set of motion vectors (53); and
coding a refinement for the fifth motion vector (54).

5. The method according to claim 2, wherein said step of determining whether to use one or more spatial scale prediction motion vectors includes:
determining a first set of four motion vectors (61);
determining a fifth motion vector such that each of the motion vectors in the first set of motion vectors requires a minimal number of bits (62);
coding the fifth motion vector (63); and
coding a refinement for the each of the motion vectors in the first set of motion vectors (64).

6. The method according to claim 2, wherein said step of determining whether to use one or more spatial scale prediction motion vectors includes:
determining three motion vectors (71);
estimating two additional motion vectors as a refinement of the three motion vectors (72);
coding each of the three motion vectors (73); and
coding a refinement for the two additional motion vectors (74).

7. The method according to claim 3, wherein said step of determining whether to use one or more orientation subband prediction motion vectors includes:
determining a first motion vector (81);
estimating two additional motion vectors as refinements of the first motion vector (82);
coding the first motion vector (83); and
coding a refinement for the two additional motion vectors (84).

8. The method according to claim 1, wherein the cost function in each of the determining steps comprises a function of rate, distortion and complexity.

9. The method according to claim 1, wherein the combining includes:
calculating a weighted average of all prediction motion vectors determined to be used.

10. The method according to claim 1, wherein the combining includes calculating a mean of all prediction motion vectors determined to be used.

11. A method for computing a plurality of motion vectors for a frame in a full-motion video sequence, comprising:
computing one or more spatial scale prediction motion vectors (PMV_{SS}) and an associated cost of the one or more spatial scale prediction motion vectors (PMV_{SS}) (42b).
computing one or more orientation subband prediction motion vectors (PMV_{OS}) and an associated cost of the one or more orientation subband prediction motion vectors (PMV_{OS}) (44b); and
combining all prediction motion vectors (45) and using the combined prediction for estimating and encoding a current motion vector (46).

12. The method according to claim 11, further comprising:
computing one or more temporal scale prediction motion vectors (PMV_{TS}) and an associated cost of the one or more temporal scale prediction motion vectors (PMV_{TS}) (41b).

13. The method according to claim 11, further comprising:
computing one or more spatial neighbor prediction motion vectors (PMV_{SN}) and an associated cost of the one or more spatial neighbor prediction motion vectors (PMV_{SN}) (43b);

14. The method according to claim 11, wherein said computing one or more spatial scales prediction motion vectors includes:
determining a first set of four motion vectors (51);
estimating a fifth motion vector based on the first set (52);
coding each motion vector in the first set of motion vectors (53); and
coding a refinement for the fifth motion vector (54).

15. The method according to claim 11, wherein said computing one or more spatial scales prediction motion vectors includes:
determining a first set of four motion vectors (61);
determining a fifth motion vector such that each of the motion vectors in the first set of motion vectors requires a minimal number of bits (62);
coding the fifth motion vector (63); and
coding a refinement for the each of the motion vectors in the first set of motion vectors (64).

16. The method according to claim 11, wherein said computing one or more spatial scales prediction motion vectors includes:
determining a three motion vectors (71);
estimating two additional motion vectors as a refinement of the three motion vectors (72);
coding each of the three motion vectors (73); and
coding a refinement for the two additional motion vectors (74).

17. The method according to claim 11, wherein said computing one or more orientation subband prediction motion vectors includes:
determining a first motion vector (81);
estimating two additional motion vectors as refinements of the first motion vector (82);
coding the first motion vector (83); and
coding a refinement for the two additional motion vectors (84).

18. The method according to claim 11, wherein the associated cost in each of the computing steps comprises a function of rate, distortion and complexity.

19. The method according to claim 11, wherein the combining includes:
calculating a weighted average of all of the prediction motion vectors.

20. The method according to claim 11, wherein the combining includes calculating a mean of all of the prediction motion vectors.
